(19) United States
(12) Patent Application Publication
(10) Pub. No.: US 2022/0224530 A1
(43) Pub. Date: Jul. 14, 2022

(54) SYSTEM FOR RESTORING LOST PRIVATE KEY

(71) Applicant: DIGIFIANCE PTE. LTD., Seoul (KR)

(72) Inventors: Ki Ook JEOUNG, Seoul (KR); Se Hyun KIM, Yongin-si, Gyeonggi-do (US)

(73) Assignee: DIGIFIANCE PTE. LTD., Seoul (KR)

(21) Appl. No.: 17/613,063

(22) PCT Filed: May 21, 2020
(86) PCT No.: PCT/KR2020/006633

§ 371 Date: Nov. 20, 2021

(30) Foreign Application Priority Data
May 21, 2019 (KR) 10-2019-0059748
Apr. 3, 2020 (KR) 10-2020-0041182

(51) Int. Cl. H04L 9/08; G06Q 20/36

(52) U.S. Cl. CPC H04L 9/0894; H04L 2209/56; G06Q 20/36

(57) ABSTRACT

The present disclosure relates to a system for restoring a lost private key. More specifically, in the system, an extra private key is split into a plurality of parts, the parts are double-encrypted and stored in external servers, and when a key used has been lost, the pieces of the private key are downloaded from the respective servers through authentication and decrypted for use. The system includes at least: a terminal that generates a reference key when a driving signal is input, converts the reference key to an encryption key, splits the encryption key into a plurality of parts to generate a plurality of the partial encryption keys, performs secondary encryption on one of the partial encryption keys with a preset authentication code, and receives and decrypts the partial encryption keys stored in the server unit when a loss signal is input from outside.

### TECHNICAL FIELD

The present disclosure relates to technology for cryptocurrency and an electronic wallet.

### BACKGROUND ART

In modern society, many things that are important to individuals have been digitized. For example, bonds and money have been digitized. As part of digitization, a currency using encryption technology, that is, a cryptocurrency, has been developed. The cryptocurrency is stored in a space where a private key is encrypted with TrueCrypt.

Although the cryptocurrency is encrypted and stored, as the value of the cryptocurrency increases, the cryptocurrency becomes a prime target for hackers and may actually be lost. For example, even when a private key is stored in a cloud server, the cloud server may be hacked and the private key may be leaked, resulting in hacking of an electronic wallet. In addition, when a private key code, a mnemonic, a wallet password, etc. are lost in a cloud server, the user is unable to recognize the loss of primary keys.

Therefore, currently, there is a need for a technology that prevents the loss of a primary key, increases the security of storage of the primary key, and prevents a hacker from decrypting the primary key even though the primary key has been lost.

### DISCLOSURE

### Technical Problem

The present disclosure is intended to solve the problems of a low security of a private key in storage, the leakage of the private key, and the loss of a cryptocurrency.

To solve the problems, according to the present disclosure, a private key is split into a plurality of parts after encryption, and stored in individual servers, respectively, and when needed, the partial primary keys resulting from splitting which are stored in the individual servers are collected and decrypted for use.

That is, according to the present disclosure, a primary key, such as a private key or a mnemonic, is stored in a distributed manner, and when needed, the distributed partial encryption keys are downloaded and decrypted for use.

The problems to be solved by the present disclosure are not limited to the problems described above, and other problems not stated obviously may be solved.

### Technical Solution

The present disclosure for solving the problems relates to a system for restoring a lost private key. More specifically, the present disclosure relates to a system for preventing a cryptocurrency in an electronic wallet from being lost, by enabling an extra private key to be used when needed and managing the electronic wallet securely.

The system includes: a server unit including a plurality of server modules configured to perform communication over a network, store different partial encryption keys, and be activated with different authentication codes; and

a terminal unit configured to generate a reference key when a driving signal is input, convert the reference key to an encryption key, split the encryption key into a plurality of parts to generate a plurality of the partial encryption keys, perform secondary encryption on any one of the partial encryption keys with a preset authentication code so as to transmit the one resulting from secondary encryption to the server unit, and receive and decrypt the partial encryption keys stored in the server unit when a loss signal is input from outside, so as to generate and display the encryption key.

The driving signal may be letters, and

the terminal unit may be configured to generate the reference key with the letters arranged in order of reception, convert the reference key to the encryption key, assign one hash code, and split the encryption key into the plurality of the parts so as to generate the plurality of the partial encryption keys.

The server modules may include a first server module and a second server module,

the first server module may be configured to generate a first authentication code and transmit the first authentication code to the terminal unit, and the second server module may be configured to generate a second authentication code different from the first authentication code and transmit the second authentication code to the terminal unit,

the first server module may be configured to transmit the partial encryption key stored in the first server module to the terminal unit only when the first authentication code is received through the terminal unit, and

the second server module may be configured to transmit the partial encryption key stored in the second server module to the terminal unit only when the second authentication code is received through the terminal unit.

The terminal unit may include:

a key generation module configured to generate, when a plurality of the letters are received, the reference key with the letters arranged in order of reception;

an electronic wallet module configured to be activated when the reference key is received, so as to set a transaction in a cryptocurrency;

an encryption key split module configured to encrypt the reference key to generate the encryption key, and split the encryption key to generate the plurality of the partial encryption keys;

a network module configured to communicate with the server unit, and transmit the partial encryption keys to the different server modules of the server unit, respectively, or receive the partial encryption keys stored in the server unit; and

a decryption module configured to receive, when the loss signal is applied and a first authentication code or a second authentication code is received, the partial encryption key corresponding to the first authentication code through the network module, and decrypt the partial encryption keys to generate the encryption key.

The key generation module may include

a reference key generator configured to receive the plurality of the letters, and generate the reference key with the letters arranged in order,

the encryption split module may include:

a word generator configured to receive the letters from the reference key generator, and generate words randomly, with the letters set as the reference key as the first letters; and an order mixer configured to mix and display the order of the randomly generated words in disorder, and

the decryption module may include:

a sorter configured to enable the order of the words to be changed, the order being generated by the word order mixer; and

a wallet activator configured to compare information on the changed order of the words in the sorter with the reference key transmitted to the reference key generator, and activate the electronic wallet module only when the first letters of the words in the changed order are the same as the reference key.

The server unit may include at least any one selected from a group of:

a first authentication code security part configured to generate the first authentication code, and receive the first authentication code back through the terminal unit;

a second authentication code security part configured to generate the second authentication code, and receive the second authentication code back through the terminal unit; and

a third authentication code security part configured to receive back, through the terminal unit, a preset terminal identification number (IMEI: International Mobile Equipment Identity) or a preset user birth date and user name.

The network module may be configured to,

when the loss signal is input to the decryption module,

receive any one of the partial encryption keys that is stored in any one of the server modules of the server unit when the first authentication code is input through the first authentication code security part,

receive another one of the partial encryption keys that is stored in another one of the server modules of the server unit when the second authentication code is input through the second authentication code security part, and

receive still another one of the partial encryption keys that is stored in still another one of the server modules of the server unit when the terminal identification number equal to a third authentication code preset in the third authentication code security part is received.

### Advantageous Effects

In the system for restoring a lost private key according to the present disclosure, even when the user has lost a private key, user authentication is performed through several steps with different methods and then, a plurality of double-encrypted private keys resulting from splitting is downloaded and decrypted for use. Further, the present disclosure enables an electronic wallet to be used securely although a key used has been lost.

### DESCRIPTION OF DRAWINGS

FIG. 1 is a flowchart illustrating the operation of a system for restoring a lost private key according to an embodiment of the present disclosure.

FIG. 2 is a block diagram illustrating a system for restoring a lost private key according to an embodiment of the present disclosure.

FIG. 3 is a diagram illustrating in detail elements of modules constituting the terminal of FIG. 1.

FIG. 4 is a diagram illustrating an operation state of the key generation module of FIG. 3.

FIGS. 5 and 6 are diagrams illustrating an operation state of the encryption key split module of FIG. 3.

FIGS. 7 and 8 are diagrams illustrating a process in which a user becomes a member of a service using a system for restoring a lost private key.

FIG. 9 is a diagram illustrating a state in which a terminal unit transmits a plurality of partial encryption keys to a server unit.

FIGS. 10 to 13 are diagrams illustrating a state in which a server unit transmits a plurality of partial encryption keys to a terminal unit and the terminal unit encrypts the partial encryption keys.

### BEST MODE

Advantages and features of the present disclosure and elements for achieving the same will be described in detail with reference to the accompanying drawings. A description described below and the accompanying drawings are provided to inform those skilled in the art to which the present disclosure pertains, about the scope of the disclosure completely. Accordingly, the scope of the present disclosure is not limited by the following description and the drawings. The scope of the present disclosure is defined only by the appended claims.

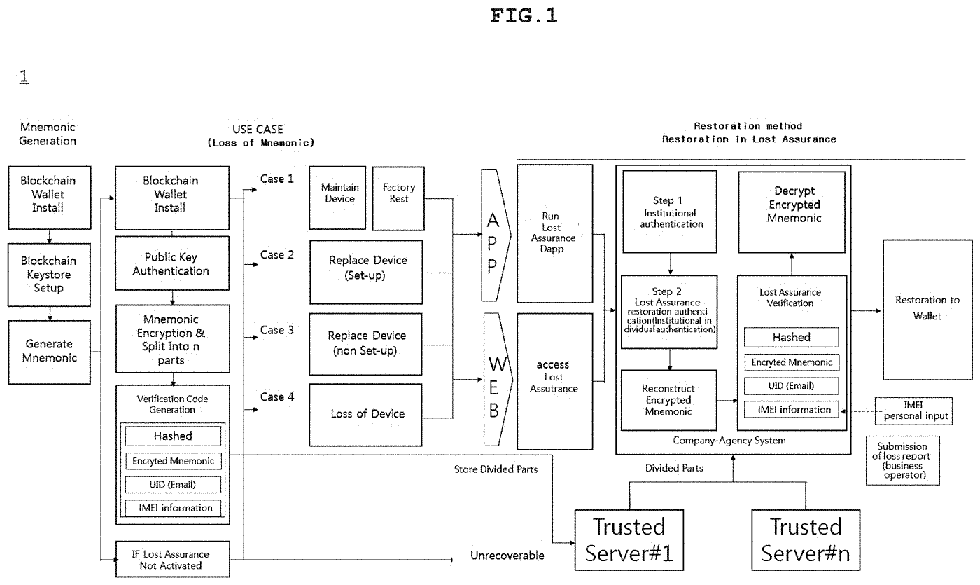

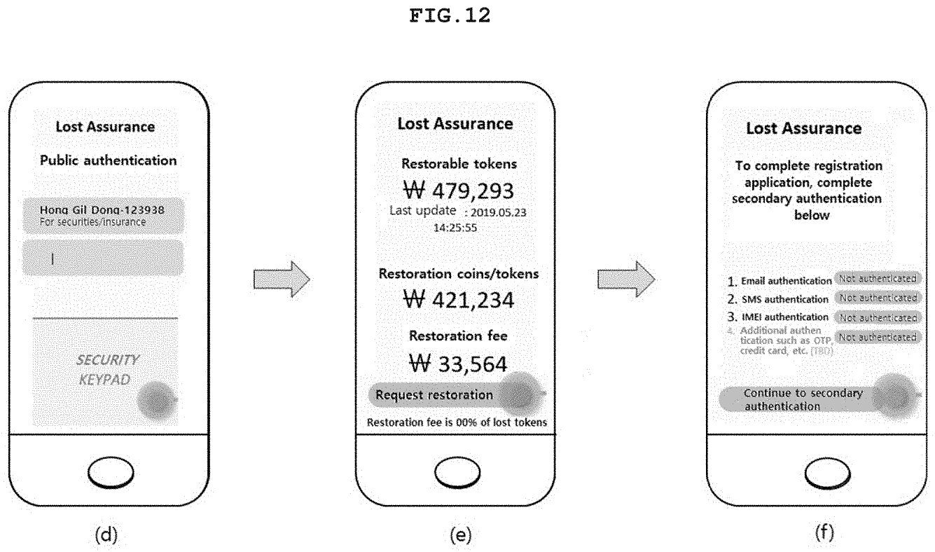

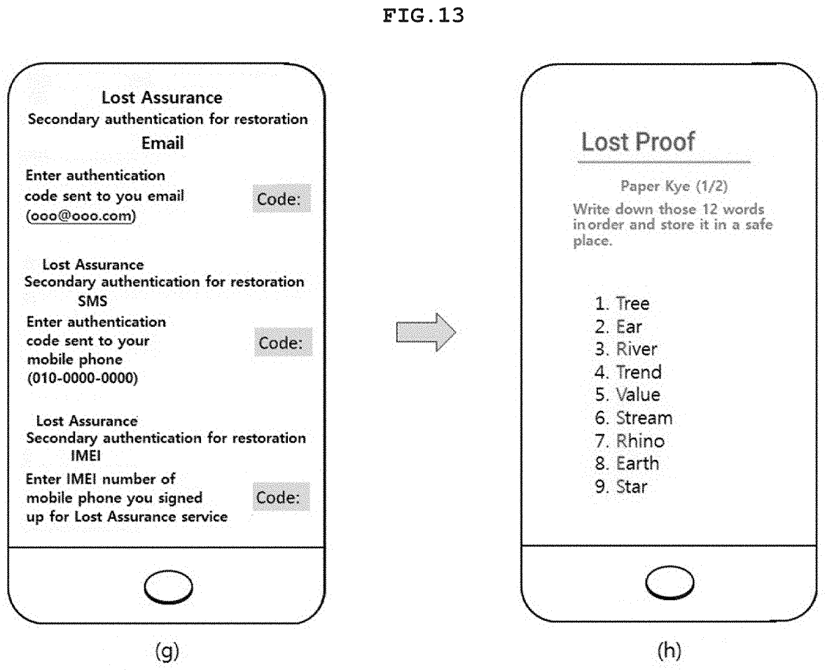

Hereinafter, a system for restoring a lost private key according to an embodiment of the present disclosure will be described in detail with reference to FIGS. 1 to 13. However, to simplify the description in this specification, a system for restoring a lost private key will be schematically described with reference to FIG. 1, and on the basis of this, the elements and the operation of the system for restoring a lost private key will be described in detail.

FIG. 1 is a flowchart illustrating the operation of a system for restoring a lost private key according to an embodiment of the present disclosure.

In the system 1 for restoring a lost private key, even when the user has lost a reference key, partial encryption keys stored in a plurality of server modules are authenticated through several steps and different authentication means and the partial encryption keys are downloaded through a terminal unit. The downloaded partial encryption keys are decrypted for use. According to the present disclosure, an extra reference key is stored securely, and even when a key used has been lost, an electronic wallet is usable with the extra reference key.

The system 1, which has such a characteristic, for restoring a lost private key includes a server unit 10 and a terminal unit 20 as elements.

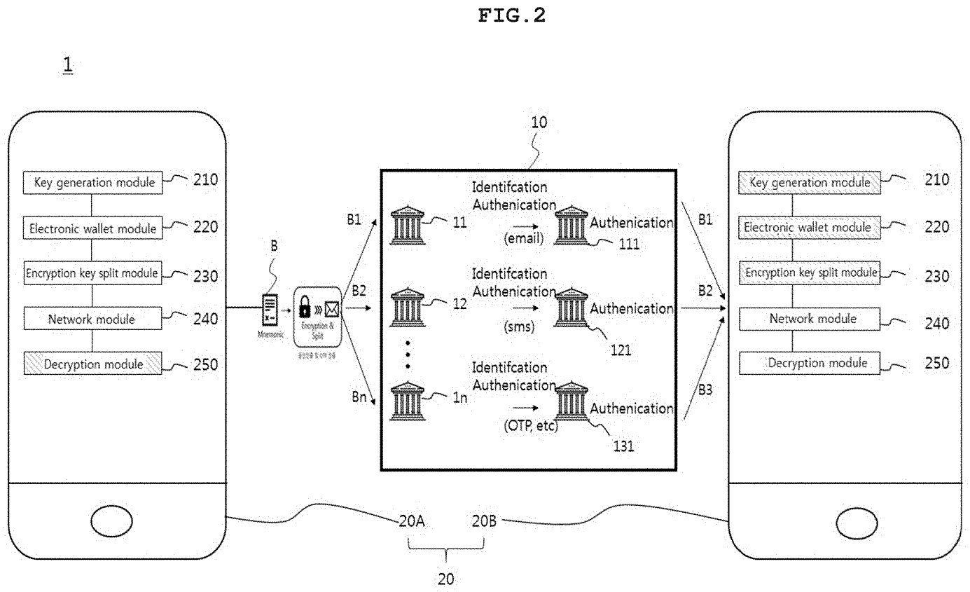

Hereinafter, elements in the present disclosure and characteristics of each of the elements will be described in detail with reference to FIGS. 2 to 6.

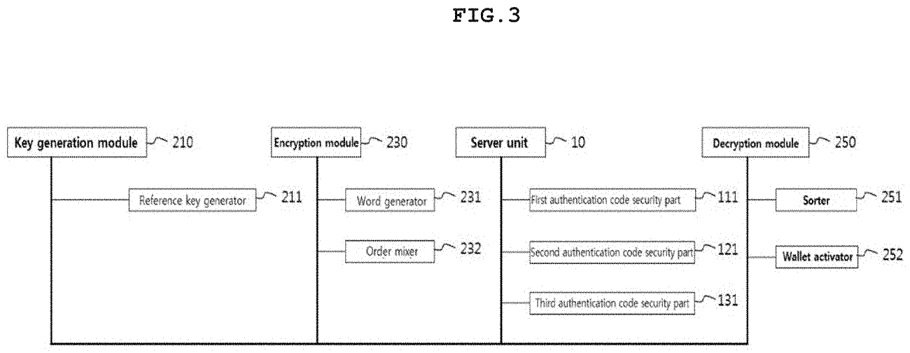

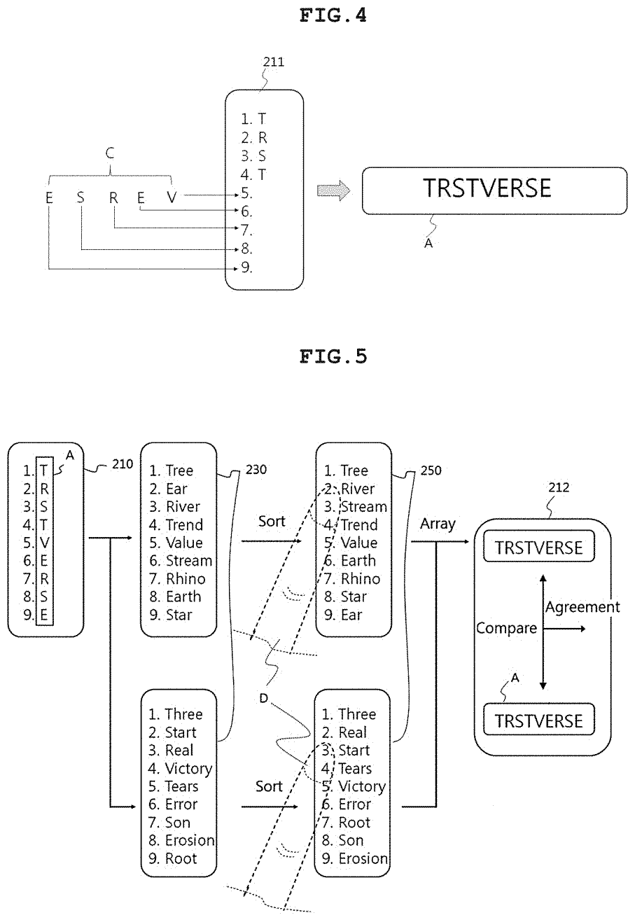

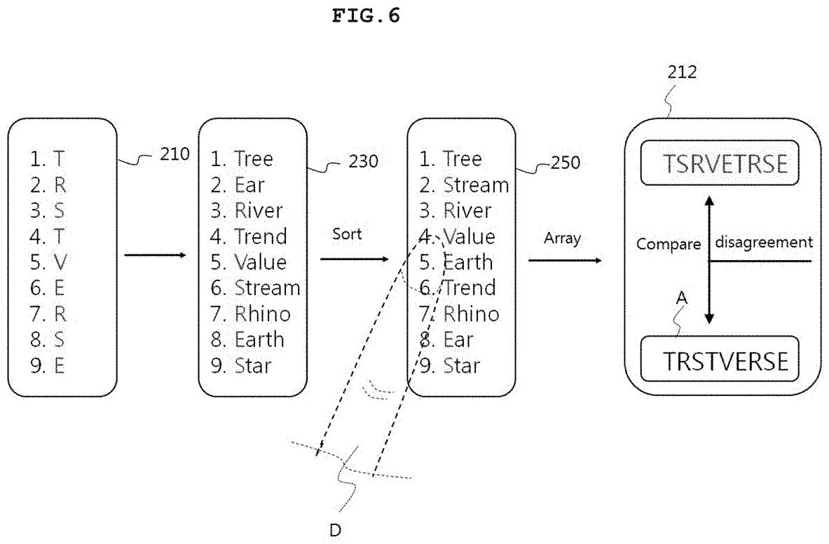

FIG. 2 is a block diagram illustrating a system for restoring a lost private key according to an embodiment of the present disclosure. FIG. 3 is a diagram illustrating in detail elements of modules constituting the terminal of FIG. 1. FIG. 4 is a diagram illustrating an operation state of the key generation module of FIG. 3. In addition, FIGS. 5 and 6 are diagrams illustrating an operation state of the encryption key split module of FIG. 3.

The server unit 10 is activated through different authentication means, and is a server that ensures integrity of data. The server unit 10 include a plurality of server modules. For example, the server unit 10 is composed of the following: a first server module 11 for generating a first authentication key and transmitting the same to the terminal unit 20; a second server module 12 for generating a second authentication key different from the first authentication key and transmitting the second authentication key to the terminal unit 20; and an n-tph server module 1n that is activated by receiving a third authentication key transmitted from the terminal unit 10.

Herein, the first server module 11 may include a first authentication code security part 111 generating a first authentication code, and may receive the first authentication code through the terminal unit 20. The first server module 11 may transmit a partial encryption key (B1˜Bn) stored therein to the terminal unit 20. For example, when a code, that is, the first authentication code, is transmitted to the user's email through the first authentication code security part 111 and the first authentication code is input through the terminal unit 20, the first server module 11 transmits the partial encryption key (B1˜Bn) stored in the first server module 11 to the terminal unit 20.

The second server module 12 may include a second authentication code security part 121 generating a second authentication code, and may receive the second authentication code through the terminal unit 20. For example, when a code, that is, the second authentication code is transmitted to the terminal of the user through the second authentication code security part 121 and the second authentication code is input through the terminal unit 20, the second server module 12 transmits the partial encryption key stored in the second server module 12 to the terminal unit 20. The n-th server module 1n may include a third authentication code security part 131 in which a third authentication code is preset, and may receive the third authentication code through the terminal unit 20. For example, when a terminal identification number (IMEI: International Mobile Equipment Identity), that is, the third authentication code, is input to the terminal of the user through the third authentication code security part 131, the n-th server module 1n transmits the partial encryption key stored in the n-th server module 1n to the terminal unit 20.

As described above, the server unit 10 is composed of the first server module 11 to the n-th server module 1n that are activated with different authentication keys, and when different authentication codes are input, the server unit 10 transmits different partial encryption keys B1 to Bn transmitted from the terminal unit 20, back to the terminal unit 20.

When the terminal unit 20 receives a driving signal, the terminal unit 20 generates a reference key A and converts the reference key A to an encryption key B. The terminal unit 20 transmits a plurality of partial encryption keys B1 to Bn to the server unit 10, and downloads the transmitted partial encryption keys B1 to Bn back to use the partial encryption keys B1 to Bn as base keys, thereby activating the electronic wallet.

In addition, to transmit the plurality of partial encryption keys B1 to Bn to the server unit 10, when the reference key A is input, the terminal unit 20 converts the reference key A to the encryption key B, and splits the encryption key B into a plurality of parts to generate the plurality of partial encryption keys B1 to Bn. Herein, when converting the reference key A to the encryption key B, the terminal unit 20 assigns one hash code. Then, the partial encryption keys are double-encrypted with a preset authentication code and transmitted to the server unit 10. Herein, the preset authentication code may be the terminal identification number (IMEI: International Mobile Equipment Identity) described above, or the user's name and the user's date of birth.

To download the transmitted partial encryption keys B1 to Bn back, the terminal unit 20 needs to transmit the authentication codes, that is, the first authentication code and the second authentication code, generated by the server unit 10 back to the server unit 10.

The terminal unit 20 may be either a smartphone or a computer. In this specification, to describe the terminal unit 20 concisely and clearly, the case in which the terminal unit 20 is a smartphone is described as an example. In addition, as shown in FIG. 2, regarding the terminal unit 20, a terminal 20A is in a state of transmitting a plurality of partial encryption keys B1 to Bn to the server unit 10, and a terminal 20B is in a state of downloading the plurality of partial encryption keys B1 to Bn stored in the server unit 10 and of decrypting the same. The terminal 20A and the terminal 20B are the same terminal.

The terminal unit 20 includes an application composed of a key generation module 210, an electronic wallet module 220, an encryption key split module 230, a network module 240, and a decryption module 250, as shown in FIG. 3. Such modules operate differently depending on the case of transmitting the partial encryption keys B1 to Bn to the server unit 10 or the case of receiving the partial encryption keys B1 to Bn from the server unit 10. For example, the key generation module 210, the electronic wallet module 220, the encryption key split module 230, and the network module 240 operate when the plurality of partial encryption keys B1 to Bn are transmitted to the server unit 10. Conversely, the decryption module 250 operates when the plurality of partial encryption keys B1 to Bn are received from the server unit 10. Herein, the key generation module 210 is an arithmetic device for generating the reference key A. The key generation module 210 includes a reference key generator 211, and when a plurality of letters (C) are received through the reference key generator 211, a reference key A is generated with the received letters arranged in order of reception. For example, as shown in FIG. 4, when the letters “T”, “R”, “S”, “T”, “V”, “E”, “R”, “S”, and “E” are input in that order, the key generation module 210 generates a reference key A with the letters arranged in order of input. Herein, the generated reference key A may be a primary key formed by the user, and is used as a reference value for determining whether it is allowed to decrypt the encryption key B, which will be decrypted later. Further, the generated reference key A may be a value for activating the electronic wallet module 220.

The electronic wallet module 220 stores a digitized cryptocurrency therein for use. In the electronic wallet module 220, deposit information and withdrawal information of the cryptocurrency may be displayed. When a reference key A, for example, a plurality of mnemonics, set by the user is input, the electronic wallet module 220 enables the stored cryptocurrency to be deposited or withdrawn.

In addition, the reference key A may be made into a plurality of copies thereof before or after being used in the electronic wallet module 220. Thus, any one reference key A may be used by the user, and another one may be encrypted and split into a plurality of parts to be transmitted to the plurality of server modules 11 to 1n.

The encryption key split module 230 encrypts the reference key A into the encryption key B. The encryption key split module 230 may include: a word generator 231 that receives the letters (C) from the reference key generator 211 and generates words randomly, with the letters set as the reference key A as the first letters; and an order mixer 232 that mixes and displays the order of the randomly generated words in disorder. Through this, the encryption key split module 230 encrypts and splits the letters (C), such as “T”, “R”, “S”, “T”, “V”, “E”, “R”, “S”, and “E”, into “Tree”, “Ear”, “River”, “Trend”, “Value”, “Stream”, “Rhino”, “Earth”, and “Star” as shown in FIG. 5. Alternatively, the letters may be encrypted and split to generate “Three”, “Start”, “Real”, “Victory”, “Tears”, “Error”, “Son”, “Erosion”, and “Root”. The partial encryption keys resulting from splitting may include HASH data that enables the partial encryption keys to be connected to each other.

The network module 240 communicates with the server unit 10, and transmits the partial encryption keys B1 to Bn to the different server modules of the server unit 10, respectively, or receives the partial encryption keys B1 to Bn stored in the server unit 10. More specifically, the network module 240 may transmit the partial encryption keys B1 to Bn generated through split by the encryption key split module 230, to different server modules. For example, the word “Tree” resulting from splitting may be transmitted to the first server module 11, and the word “Ear” may be transmitted to the second server module 12. The word “Star” may be transmitted to the n-th server module 1n. In addition, when a loss signal is input to the decryption module 250 through the user and the first authentication code is input through the first authentication code security part 101, the network module 240 receives any one partial encryption key B1, that is, “Tree”, stored in the first server module 11. When the second authentication code is input through the second authentication code security part 102, the network module 240 receives another partial encryption key B2, that is, “Ear”, stored in the second server module 12. When the terminal identification number equal to the third authentication key preset in the third authentication code security part 103 is received, another partial encryption key Bn, that is, “Star”, stored in another server module 1n of the server unit is received. The received partial encryption key is transmitted to the decryption module 250.

The decryption module 250 generates a decryption key for decrypting the partial encryption keys B1 to Bn, and decrypts the partial encryption keys. In addition, when a loss signal is applied and the first authentication code or the second authentication code is received, the decryption module 250 receives the partial encryption key (B1˜Bn) corresponding to the first authentication code through the network module 240, and decrypts the partial encryption keys B1 to Bn to generate the encryption key B.

In addition, the decryption module 250 may include a sorter 251 and a wallet activator 252. Herein, as shown in FIG. 5, the sorter 251 enables the user D to change the word order generated by the word order mixer 231. Herein, as shown in FIG. 5, when the user arranges the first letters of the encryption keys mixed in disorder in the same order as in the letter order of the reference key A, or inputs the first letters of the encryption keys mixed in disorder in the same order as in the letter order of the reference key A, the electronic wallet module 220 is activated. Conversely, as shown in FIG. 6, when the user arranges the first letters of the encryption keys mixed in disorder in a different order than in the letter order of the reference key A, or inputs the first letters of the encryption keys in a different order than in the letter order of the reference key A, the electronic wallet module 220 is not activated.

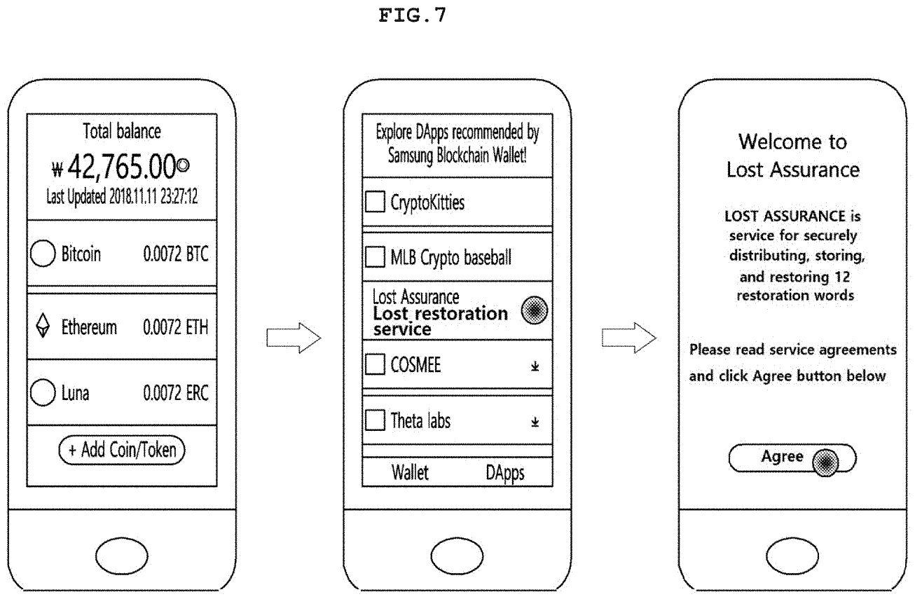

Hereinafter, the operation of a system for restoring a lost private key will be described in sequence with reference to FIGS. 7 to 13.

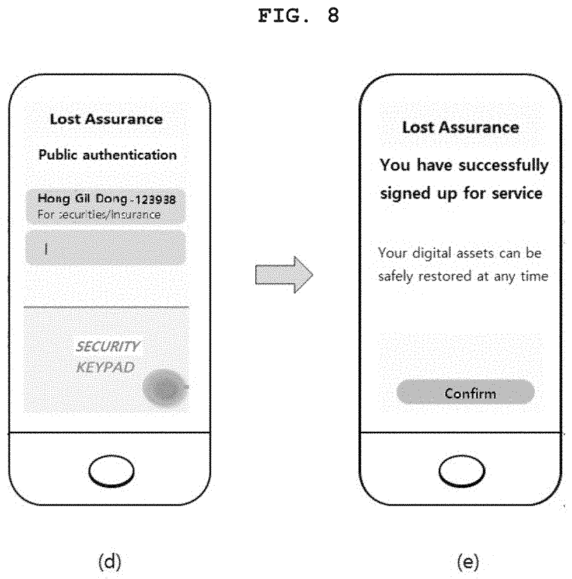

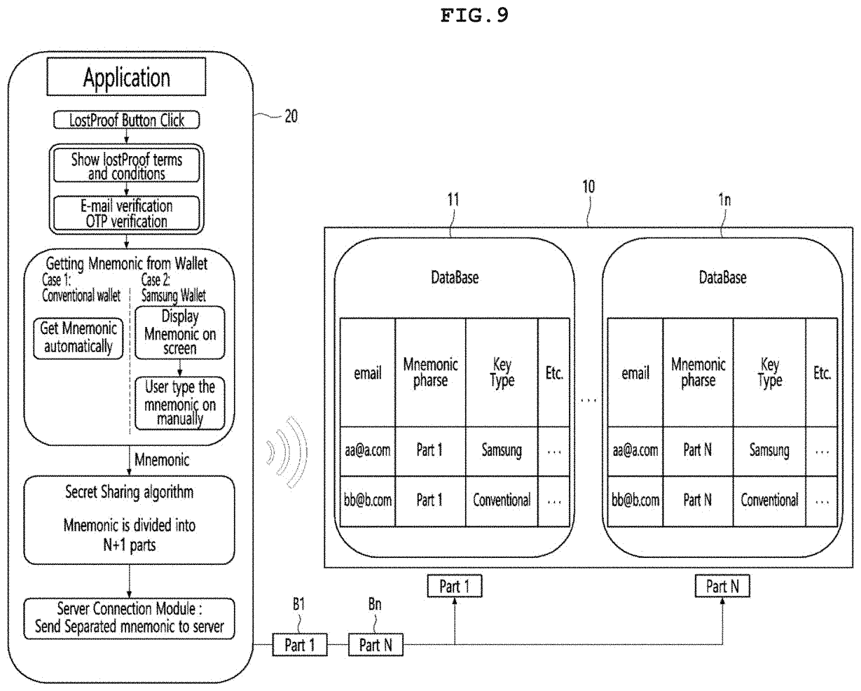

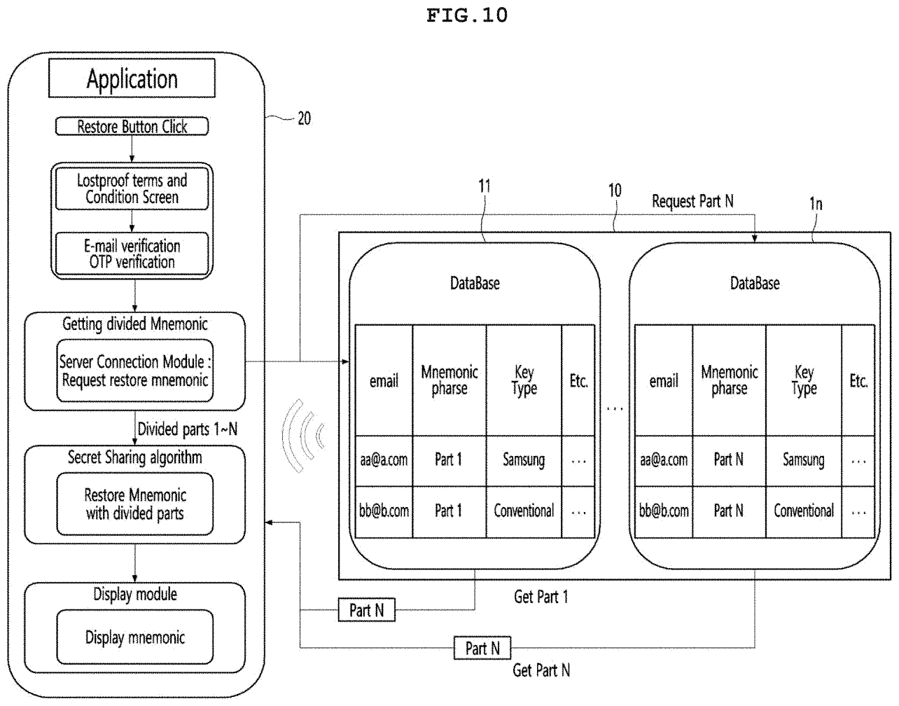

FIGS. 7 and 8 are diagrams illustrating a process in which a user becomes a member of a service using a system for restoring a lost private key. FIG. 9 is a diagram illustrating a state in which a terminal unit transmits a plurality of partial encryption keys to a server unit. In addition, FIGS. 10 to 13 are diagrams illustrating a state in which a server unit transmits a plurality of partial encryption keys to a terminal unit and the terminal unit encrypts the partial encryption keys.

First, a process in which the user becomes a member of a service using the system for restoring a lost private key so as to use the system for restoring a lost private key will be described with reference to FIGS. 7 and 8. FIGS. 7 and 8 are diagrams illustrating a process in which a user becomes a member of a service using a system for restoring a lost private key.

As shown in FIG. 7(a), starting from the step of installing the electronic wallet module 220 on the terminal unit 20, the user may follow the procedure for joining the system for restoring a lost private key. Afterward, the user may complete the joining procedure through the following steps: selecting a lost restoration service Lost Assurance among blockchain DApps as shown in FIG. 7(b), becoming a member of the lost restoration service Lost Assurance as shown in FIG. 7(c), setting public authentication in the lost restoration service Lost Assurance as shown in FIG. 7(d), and confirming the completion of the joining procedure as shown in FIG. 7(e). That is, through the steps as shown in FIGS. 7 and 8, the user is able to use the system for restoring a lost private key.

Afterward, as shown in FIG. 9, the user activates the application installed on the terminal unit 20 so that a plurality of partial encryption keys B1 to Bn are generated and the generated partial encryption keys B1 to Bn are transmitted to a plurality of server modules 11 to 1n, respectively. Herein, the plurality of server modules 11 to 1n stores therein the transmitted partial encryption keys B1 to Bn through different authentication codes.

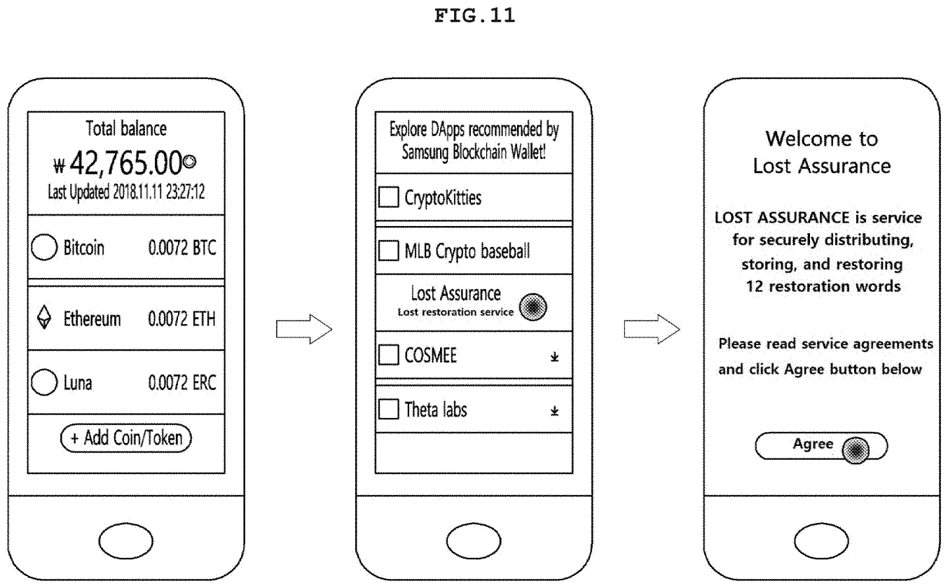

In addition, when the user has lost an encryption key B for activating the electronic wallet module 220, the application is activated so that the plurality of partial encryption keys B1 to Bn are received from the plurality of server modules 11 to in to the terminal unit 20 as shown in FIG. 10. More specifically, when the user has lost an encryption key B for activating the electronic wallet module 220, the encryption key B for activating the electronic wallet module 220 is restored according to the procedure shown in FIGS. 11 to 13. Through such restoration of the encryption key, the electronic wallet module 220 may be activated.

Although the embodiments of the present disclosure have been described with reference to the accompanying drawings, those skilled in the art to which the present disclosure pertains will understand that the present disclosure can be embodied in other specific forms without changing the technical idea or essential characteristics of the present disclosure. Therefore, it should be understood that the embodiments described above are illustrative in all aspects and not restrictive.

1. A system for restoring a lost private key, the system comprising:
a server unit (10) including a plurality of server modules (11˜1n) configured to perform communication over a network, store different partial encryption keys (B1˜Bn), and be activated with different authentication codes; and
a terminal unit (20) configured to generate a reference key (A) when a driving signal is input, convert the reference key (A) to an encryption key (B), split the encryption key (B) into a plurality of parts to generate a plurality of the partial encryption keys (B1˜Bn), perform secondary encryption on any one of the partial encryption keys (B1˜Bn) with a preset authentication code so as to transmit the one resulting from secondary encryption to the server unit (10), and receive and decrypt the partial encryption keys (B1˜Bn) stored in the server unit (10) when a loss signal is input from outside, so as to generate and display the encryption key.

2. The system of claim 1, wherein the driving signal is letters, and
the terminal unit (20) is configured to generate the reference key (A) with the letters arranged in order of reception, convert the reference key (A) to the encryption key (B), assign one hash code, and split the encryption key (B) into the plurality of the parts so as to generate the plurality of the partial encryption keys (B1˜Bn).

3. The system of claim 1, wherein the server modules (11˜1n) include a first server module (11) and a second server module (12),
the first server module (11) is configured to generate a first authentication code and transmit the first authentication code to the terminal unit (20), and the second server module (12) is configured to generate a second authentication code different from the first authentication code and transmit the second authentication code to the terminal unit (20),
the first server module (11) is configured to transmit the partial encryption key stored in the first server module (11) to the terminal unit (20) only when the first authentication code is received through the terminal unit (20), and
the second server module (12) is configured to transmit the partial encryption key stored in the second server module (12) to the terminal unit (20) only when the second authentication code is received through the terminal unit (20).

4. The system of claim 2, wherein the terminal unit (20) comprises:
a key generation module (210) configured to generate, when a plurality of the letters are received, the reference key (A) with the letters (C) arranged in order of reception;
an electronic wallet module (220) configured to be activated when the reference key (A) is received, so as to set a transaction in a cryptocurrency;
an encryption key split module (230) configured to encrypt the reference key to generate the encryption key (B), and split the encryption key (B) to generate the plurality of the partial encryption keys (B1˜Bn);
a network module (240) configured to communicate with the server unit (10), and transmit the partial encryption keys (B1˜Bn) to the different server modules of the server unit (10), respectively, or receive the partial encryption keys (B1˜Bn) stored in the server unit (10); and
a decryption module (250) configured to receive, when the loss signal is applied and a first authentication code or a second authentication code is received, the partial encryption key (B1˜Bn) corresponding to the first authentication code through the network module (240), and decrypt the partial encryption keys (B1˜Bn) to generate the encryption key (B).

5. The system of claim 4, wherein the key generation module (210) comprises a reference key generator (211) configured to receive the plurality of the letters (C), and generate the reference key (A) with the letters arranged in order,
the encryption split module (230) comprises:
a word generator (231) configured to receive the letters from the reference key generator (211), and generate words randomly, with the letters set as the reference key (A) as the first letters; and an order mixer (232) configured to mix and display the order of the randomly generated words in disorder, and
the decryption module (250) comprises:
a sorter (251) configured to enable the order of the words to be changed, the order being generated by the word order mixer (231); and
a wallet activator (252) configured to compare information on the changed order of the words in the sorter (251) with the reference key transmitted to the reference key generator (212), and activate the electronic wallet module (220) only when the first letters of the words in the changed order are the same as the reference key.

6. The system of claim 3, wherein the server unit (10) comprises at least any one selected from a group of:
a first authentication code security part (111) configured to generate the first authentication code, and receive the first authentication code back through the terminal unit (20);
a second authentication code security part (121) configured to generate the second authentication code, and receive the second authentication code back through the terminal unit (20); and
a third authentication code security part (131) configured to receive back, through the terminal unit (20), a preset terminal identification number (IMEI: International Mobile Equipment Identity) or a preset user birth date and user name.

7. The system of claim 6, wherein the network module (240) is configured to, when the loss signal is input to the decryption module (250),
receive any one (B1) of the partial encryption keys that is stored in any one (11) of the server modules of the server unit when the first authentication code is input through the first authentication code security part (101),
receive another one (B2) of the partial encryption keys that is stored in another one (12) of the server modules of the server unit when the second authentication code is input through the second authentication code security part (102), and
receive still another one (Bn) of the partial encryption keys that is stored in still another one (1n) of the server modules of the server unit when the terminal identification number equal to a third authentication code preset in the third authentication code security part (103) is received.
